(19) United States
(12) Patent Application Publication
(10) Pub. No.: US 2015/0286327 A1
(43) Pub. Date: Oct. 8, 2015

(54) Method and Apparatus for Protecting Touch-Screen Electronic Devices

(71) Applicant: Deven Charles Chakrabarti, Moorestown, NJ (US)

(72) Inventor: Deven Charles Chakrabarti, Moorestown, NJ (US)

(21) Appl. No.: 14/669,135

(22) Filed: Mar. 26, 2015

Related U.S. Application Data
(60) Provisional application No. 61/976,049, filed on Apr. 7, 2014.

(51) Int. Cl. G06F 3/041; G02B 5/20; B32B 37/12; G02B 27/28; B32B 37/18; G02B 5/28; G02B 1/14

(52) U.S. Cl. CPC G06F 3/0412; G02B 5/282; G02B 5/287; G02B 5/208; G02B 1/14; G02B 27/286; B32B 37/18; B32B 37/12; G06F 2203/04107; B32B 2307/412; B32B 2307/42; B32B 2457/208; G06F 2203/04103

(57) ABSTRACT

Electronic devices with touch-screen displays and methods to make the same. In particular the present disclosure is directed to touch-screen electronic devices with protective heat shields on their touch-screens and more particularly to portable touch-screen devices that can be used both indoors and outdoors under conditions of direct sun light and other sources of radiation heat for an extended period of time. The disclosure also relates to method of applying heat-protective shields on the touch-screen surfaces of such devices.

### CROSS REFERENCE TO RELATED APPLICATION

This application claims the benefit of U.S. Provisional Application No. 61/976,049, entitled “Method and Apparatus for Preventing Overheating and Reducing Heat Gain due to Sunlight of Handheld Touch-screen Electronic Devices” and filed Apr. 7, 2014, the contents of which application are incorporated herein by reference.

### FIELD OF THE INVENTION

The disclosed embodiments relate generally to electronic devices with touch-screen displays and more particularly providing such devices with visually transparent, protective heat shields.

### BACKGROUND OF THE INVENTION

Though the first finger-driven touch-screen was invented in 1965 by E. H. Johnson and described in an article published by him in 1967, it took several decades for the technology to progress to a stage that it could be used in everyday electronic devices. Today in a developed society it is hard to imagine life without a trustworthy tablet or a smart phone nearby. In the modern society touch-screen electronic devices are everywhere and their user base encompasses the entire spectrum of age brackets from young children to the elderly. People use them for many purposes such as internet browsing, dinner reservations, reading e-books, receiving news and weather information, playing video games, checking if our homes are safe, and keeping in constant touch with our family members and friends. These devices are carried and used at home, at school, at work, during vacation and during leisure at places such as near the swimming pool or on the beach.

A touch-screen has the ability to detect a touch within the display area. All touch-screens have three primary elements—a sensor, a controller, and a software drive.

Based on the science behind touch-recognition functions, various types of touch-screens have been devised, each type having its own benefits and limitations. The more common among them are the following four classes.

### Resistive Touch-Screen:

A commercially viable resistive touch-screen was developed by G. Samuel Hurst and described in U.S. Pat. No. 3,911,215. FIG. 1 illustrates components of a conventional resistive touch-screen panel 100. In its simplest form, the conventional resistive touch-screen panel 100 consists of a flexible top layer 110 made of plastic and a rigid bottom layer 120 made of glass. The inside surface of the flexible top layer 110 is coated with a thin transparent conductive coating 130 such as indium titanium oxide (ITO). The bottom layer 120 is also coated with a similar transparent conductive coating 140 but this coating 140 is applied on the top of the inside surface, facing the top layer coating. One of these layers has conductive connections along its sides and the other along the top and the bottom. The two thin transparent coatings 130 and 149 are divided by insulating spacer dots 150.

When pressure is applied at any point on the flexible top layer 110 by a finger 160 (whether gloved or not) or a stylus tip (not illustrated), this layer 110 is pressed down such that the thin transparent conductive coating 130 touches the thin transparent conductive coating 250 at a point (or area) of pressure 170 and makes electrical connection at that point 170. The panel 100 then acts as a pair of voltage dividers, one axis at a time. By rapidly switching between each layer, the coordinates of the pressure point 170 on the screen can be calculated by a computer. Once the coordinates are known, a special driver translates the touch into something that the operating system can understand. Though resistive screens rank quite high on durability and are amenable to easy integration, they generally offer low visual clarity on the order of only about 75%.

### Capacitive Touch-Screen:

FIG. 2 illustrates components of a conventional capacitive touch-screen panel 200. The capacitive touch-screen panel 200 consists of a rigid top layer 210 made from an insulator, such as glass and a rigid bottom layer 220 also made form an insulator, such as glass. An inside surface of the rigid top layer 210 is coated with a conductive material 230, such as indium tin oxide (ITO). An inside surface of the rigid bottom layer 220 is also coated with a conductive material 240, such as ITO. The conductive layers 230 and 240 are separated by insulating spacer dots 250. The glass panel 210, in this construction, can store electrical charge. Since the human body is a massive electrical conductor, touching the surface of the screen 200 by a finger 260 results in a distortion of the screen's electrostatic field at a point (or area) 270 and this change can be measured as a change in capacitance. Different technologies can be used to determine the location 270 of the touch.

From an operational viewpoint, one difference between the resistive touch-screen 100 and the capacitive touch-screen 200 is that while the former does not depend on the conductive nature of the touching object, the latter requires that the touching object be a large electrical conductor. Thus one cannot operate the capacitive touch-screen 200 with a gloved finger unless the glove is specially designed with conductive elements in it. Still another difference between the resistive touch-screen 100 and the capacitive touch-screen 200 is that while former generally has low visual clarity, the has latter very good visual clarity, of the order of 90% or better. This gives the capacitive system 200 a much cleaner picture than the resistive system 100. It is for this reason most current generation hand held touch-screen electronic devices like smart phones contain capacitive touch-screens. Various modifications of the basic design have been made so as to improve the precision of the touch area and also to improve touch sensitivity of the capacitive system 200. Modern capacitive touch-screens used in multifunctional electronic devices can detect more than one touch as well as gestures. U.S. Pat. Nos. 7,479,949 B2 and 7,479,949 C2 provide a lucid and comprehensive description of the capabilities of such touch-screens.

### Surface Acoustic Wave (SAW) Touch-Screen:

A conventional surface acoustic wave (SAW) touch-screen 300 is illustrated in FIG. 3. It comprises two transducers 320 and a reflector 330 placed on a glass surface 310. The technology uses ultrasonic waves that pass over the screen panel 300. When the panel 300 is touched by a user 360, a portion of the wave is absorbed. This change in the ultrasonic waves registers the position of the touch event and sends this information to a controller for processing. In comparison with other touch-screens, SAW provides excellent clarity allowing almost 100% light throughput, high resolution, and ability to interact with a stylus or a bare or gloved finger 360. Their main drawback is that they are quite expensive and contaminants on the surface can interfere with their functionality.

### Acoustic Pulse Recognition (APR) Touch-Screen:

A basic design of a conventional acoustic pulse recognition (APR) touch-screen 400 is illustrated in FIG. 4. In its elemental form it consists of a glass overlay 410, an inner glass layer 420, and three or more transducers 430 attached to the back exterior. A touch on any position on the surface glass layer 410 generates a sound wave in the substrate which then produces a unique combined sound after being picked up by the transducers 430 attached to the edges of the touch-screen 400. The sound is then digitized by a controller and compared to a list of pre-recorded sounds for every position on the surface glass layer 410. The cursor 460 position is instantly updated to the touch location. A moving touch is tracked by rapid repetition of this process. Extraneous and surrounding sounds are not recognized since they do not match any stored sound profile. The APR technology was developed by SoundTouch Ltd in the early 2000s and is described in EP 1852772 B1. It was released to the market in 2006 by the Elo division of Tyco International. ARP touch-screens 400 are water resistant, durable and scalable. This technology is well suited for displays that are physically larger than, for instance, a smart phone.

### SUMMARY OF THE INVENTION

In accordance with an exemplary embodiment of the present invention, there is provided a multifunctional touch-screen device. The device comprises a touch-screen and a visually transparent infrared (IR)-blocking film overlaid on the touch-screen, whereby the visually transparent IR-blocking film provides prolonged workable time under conditions when the device is exposed to sunlight or to other sources of thermal radiation.

In accordance with another exemplary embodiment of the present invention, there is provided a method for attaching an IR-blocking film. The method comprises steps of providing a multifunctional touch-screen device comprising a touch-screen and attaching a visually transparent infrared (IR)-blocking film to the touch-screen using a polymeric adhesive, whereby the visually transparent IR-blocking film provides prolonged workable time under conditions when the device is exposed to sunlight or to other sources of thermal radiation.

In accordance with another exemplary embodiment of the present invention, there is provided another method for attaching a visually transparent IR-blocking film. The method comprises steps of providing a multifunctional touch-screen device comprising a touch-screen and attaching a visually transparent infrared (IR)-blocking film to the touch-screen using a polymeric adhesive comprising a curable acrylate and acrylate/epoxy material containing a dispersion of infrared-absorbing nanoparticles selected from one or more of titanium oxide, titanium nitride, niobium oxide, tantalum oxide, silicon oxide, aluminum oxide, zirconium oxide, zirconium nitride, tin oxide, indium oxide, lanthanum hexaboride, and magnesium fluoride, whereby the visually transparent IR-blocking film provides prolonged workable time under conditions when the device is exposed to sunlight or to other sources of thermal radiation.

In accordance with yet another exemplary embodiment of the present invention, there is provided yet another method for attaching a visually transparent IR-blocking film. The method comprises steps of providing a multifunctional touch-screen device comprising a touch-screen; providing a visually transparent multilayer polymeric near-infrared (NIR) reflecting film laminate with a scratch resistant plastic film or tempered glass layer; cutting the laminate into a size of the touch-screen; and sticking the visually transparent multilayer NIR reflecting film to the touch-screen by electrostatic attraction.

In accordance with yet another exemplary embodiment of the present invention, there is provided yet another method for attaching a visually transparent IR-blocking film. The method comprises steps of providing a multifunctional touch-screen device comprising a touch-screen; providing a visually transparent multilayer near-infrared (NIR) reflecting film selected from PR 40® or PR 70® film from the 3M Company; cutting the visually transparent multilayer NIR reflecting film into a size of the touch-screen; and sticking the visually transparent multilayer NIR reflecting film to the touch-screen by electrostatic attraction.

In accordance with yet another exemplary embodiment of the present invention, there is provided yet another method for attaching a visually transparent IR-blocking film. The method comprises steps of providing a multifunctional touch-screen device comprising a touch-screen; providing a visually transparent multilayer polymeric near-infrared (NIR) reflecting film laminate with a scratch resistant plastic film or tempered glass layer; cutting the laminate into a size of the touch-screen; and sticking the visually transparent multilayer NIR reflecting film to the touch-screen using a polymeric adhesive.

### BRIEF DESCRIPTION OF THE DRAWINGS

For the purpose of illustration, there are shown in the drawings certain embodiments of the present invention. In the drawings, like numerals indicate like elements throughout. It should be understood that the invention is not limited to the precise arrangements, dimensions, and instruments shown. In the drawings:

FIG. 1 illustrates a conventional resistive touch-screen;

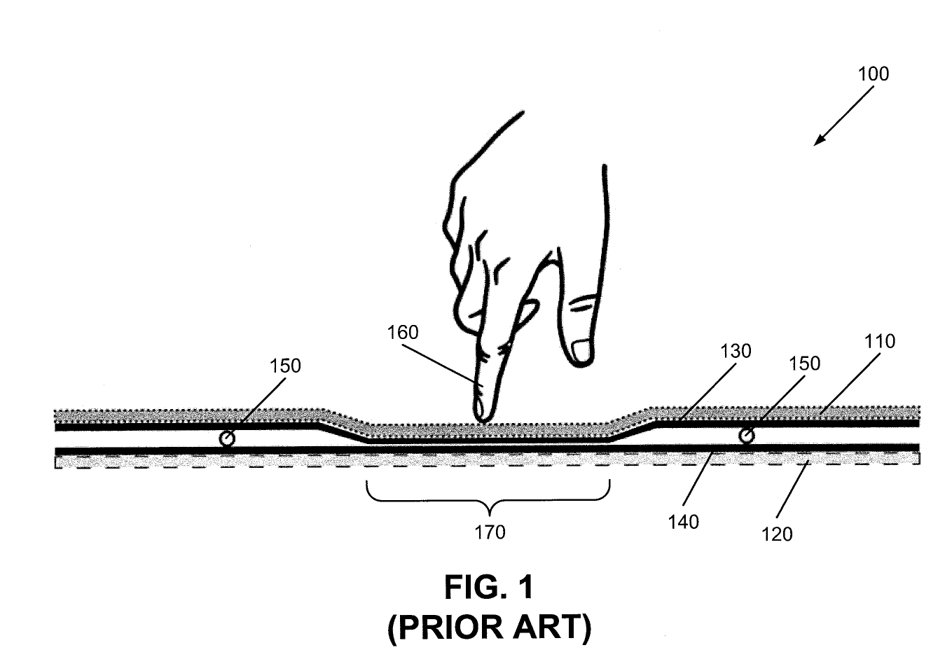

FIG. 2 illustrates a conventional capacitive touch-screen;

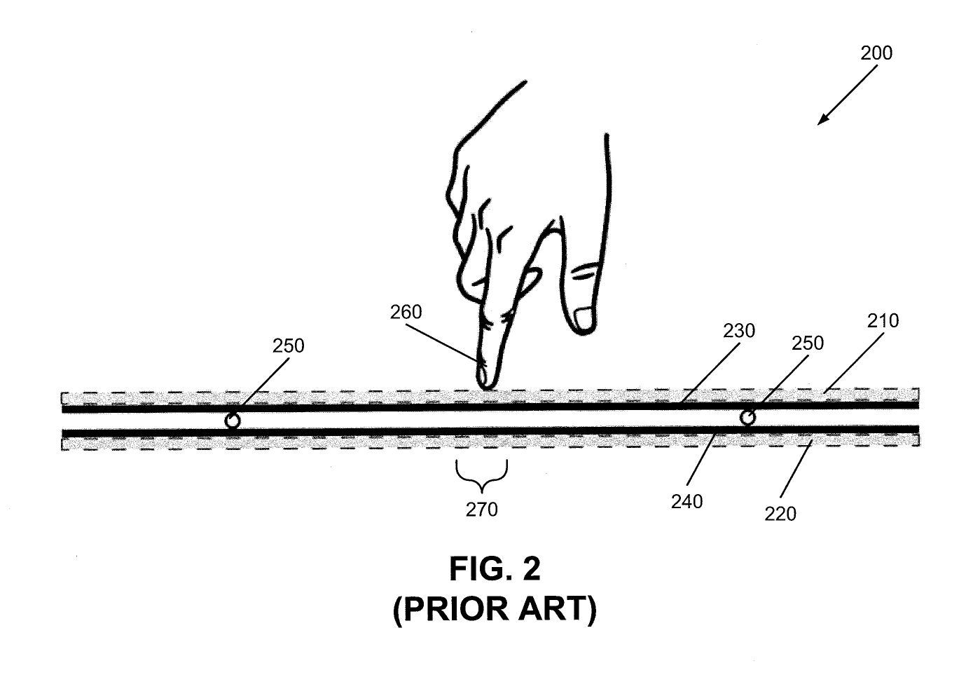

FIG. 3 illustrates a conventional surface acoustic wave touch-screen;

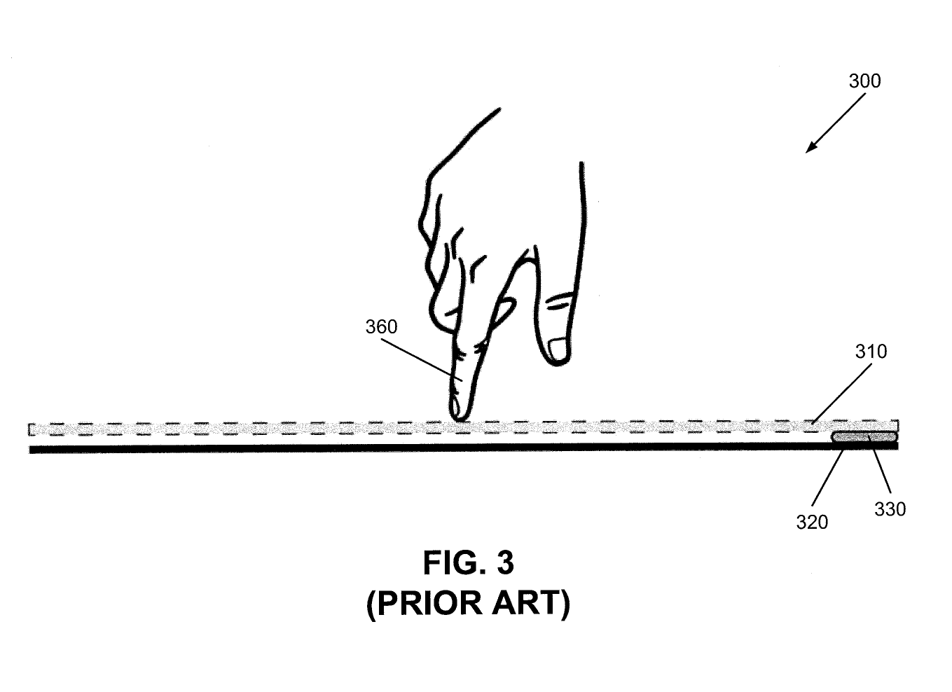

FIG. 4 illustrates a conventional acoustic pulse recognition touch-screen;

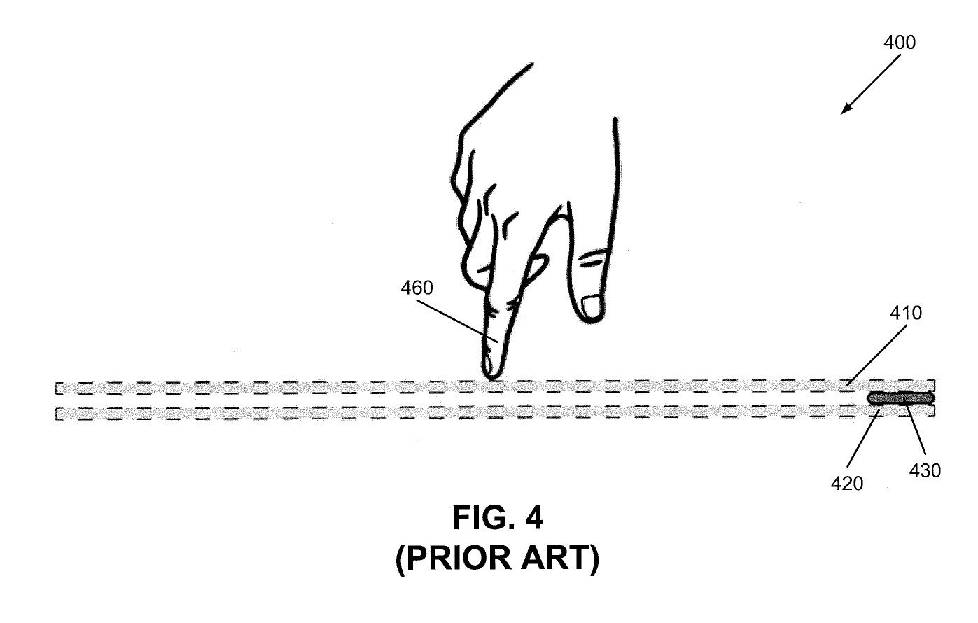

FIG. 5 illustrates a first exemplary embodiment of a touch-screen covering, in accordance with an exemplary embodiment of the present invention;

FIG. 6A illustrates a second exemplary embodiment of a touch-screen covering, in accordance with an exemplary embodiment of the present invention;

FIG. 6B illustrates a third exemplary embodiment of a touch-screen covering, in accordance with an exemplary embodiment of the present invention; and

FIG. 7 illustrates an experimental apparatus for testing infrared blocking of a touch-screen covering, in accordance with an exemplary embodiment of the present invention.

### DETAILED DESCRIPTION OF THE INVENTION

Reference to the drawings illustrating various views of exemplary embodiments of the present invention is now made. In the drawings and the description of the drawings herein, certain terminology is used for convenience only and is not to be taken as limiting the embodiments of the present invention. Furthermore, in the drawings and the description below, like numerals indicate like elements throughout.

Description of the conventional touch-screens 100 through 400 as provided above should not be considered to imply that they are stand-alone items in touch-screen electronic devices. To provide the desired functionalities of these devices the touch-screen should be integrated with other components of the device. Thus a modern smart phone or tablet may contain one or more of the following:
1. a power system,
2. one or more optical sensors and cameras,
3. one or more proximity sensors,
4. one or more accelerometers,
5. a touch pad in addition to the touch-screen for activating or deactivating particular functions,
6. RF circuitry,
7. audio circuitry,
8. a microphone,
9. a camera,
amongst other components.

The software system in a touch-screen electronic device may contain various modules including one or more of the following:
1. a GPS module,
2. a telephone module,
3. an email client module,
4. an instant messaging (IM) module,
5. a blogging module,
6. a camera module for still and/or video images,
7. an image management module,
8. a video player module,
9. a music player module,
10. a browser module,
11. a calendar module,
12. a graphics module,
13. a text input module,
14. a widget creator module,
15. several widget modules that may include and of:
   a. weather widget
   b. stocks widget
   c. calculator widget
   d. alarm clock widget
   e. other widgets obtained by the user, as well as user created widgets.
16. various other modules.

These features of a modern touch-screen multifunctional device are described in details in U.S. Pat. No. 7,479,949 B2 and C2. This patent and all the other patents and references cited therein as supporting material are incorporated by reference herein in their entirety.

In an electronic device having a touch-screen, the touch-screen may interact in an integrated manner with all of the systems and processes of the electronic device. The reason for describing, in detail, the features of the modern day touch-screen electronic devices is to stress that, if one wishes to consider modification of the touch-screen with an external overlay on it, it may not be enough to consider only the properties of the overlay material and that of the touch-screen in isolation. One may consider effect of the overlay on the entire assembly of the touch-screen electronic device to determine if the desired effect can be achieved. Accordingly, it is extremely difficult to predict the effect of an overlay on the functioning of the entire device, without actually experimenting with it on the entire device.

Furthermore, it is to be understood that the most popular consumer touch-screen devices are “multifunctional touch-screen handheld electronic devices” (MTSHED), such as tablets or smartphones. The majority of MTSHED's on the market today utilize capacitive touch-screen interfaces.

### The Problem of Overheating

Touch-screen electronic devices like many other electronic devices stop functioning when overheated. In fact, with a touch-screen iPhone, for instance, a warning appears on the screen, when the temperature of the device reaches a critical point, indicating that the device is getting overheated and will stop working. This makes it difficult to use these devices under direct sunlight for an extended period of time.

Sunlight is commonly classified to contain three spectral ranges of radiation—a) ultraviolet (UV) radiation with wavelengths ranging from 295 nm to 400 nm; b) visible light with wavelengths ranging from 400 nm to 700 nm; and c) infrared (IR) radiation with wavelengths ranging from 700 nm to 2,500 nm. The IR region is further classified as near-infrared (NIR) with wavelengths raging from 700 nm to 1200 nm and far infrared with wavelengths ranging from 1200 nm to 2,500 nm.

Solar radiation reaching the surface of the Earth starts from 295 nm because radiation with lower wavelengths is absorbed by the upper atmosphere before reaching the surface of the Earth. UV radiation comprises only 5% of solar energy, but these invisible short wavelength radiations are highly energetic and are responsible for breaking chemical bonds, and as such, they are responsible for slow degradation of organic polymers and many other organic molecules. The visible spectrum accounts for about 50% of solar radiation, and it can be detected by the human eye. It accounts for the various colors we see. Nearly 45% of solar energy lies in the infrared regions, and like UV radiation, it is also invisible. IR radiation is much less energetic than UV radiation.

IR radiation interacts with chemical bonds leading to stretching, bending, and rotation of the bonds in molecules. IR radiation is also responsible for translational movement of molecules in a material. These motions are expressed as increased temperature of the material with which IR radiation, particularly NIR radiation, interacts. Thus, the higher the amount of NIR radiation a material absorbs from sunlight, the higher its temperature is. Accordingly, NIR radiation is often called thermal radiation.

To increase the operating capabilities of a hand-held touch-screen electronic device outdoors under direct sunlight, blocking or retarding NIR radiation from entering the device through the touch-screen while allowing visible light to pass would be advantageous. Maintaining transparency of the touch-screen to visible light is important to allow the user to see the images displayed on the screen of the device.

The inventors have experimented with hand-held touch-screen devices in order to improve their effective operational time under sunlight and have made observations. When exposed to IR radiation from an IR lamp, the devices got heated much faster when their screen-sides were facing the IR source compared to when their back sides were facing the IR source. This observation may be rationalized by the fact the back side of the tested device was made of metallic material that is known for very low thermal emissivity, which means that the IR radiations falling on them was mostly absorbed or reflected back to the atmosphere. In contrast, the touch-screen side is overlaid with glass, which has almost perfect thermal emissivity, which means that the IR radiation falling on these sides did not get reflected back to the atmosphere but rather passed through the glass unobstructed and was then absorbed there by the various electronic components as well as by the bodies of the devices. Thus, the temperatures of the devices increased.

These observations were consistent with other observations, namely, that touch-screen devices, such as an iPhone or an iPad, remain operational much longer in the sun when kept upside (screen-side) down. However, keeping a touch-screen devices upside down is not always an option for various reasons, among them are: a) using a touch-screen device facing away from the sun may require a user to face the sun, and b) keeping the screen side down, such as on a patio floor, or on the deck of a boat, or on a beach, may scratch the screen. Lowering the heating rate of the touch-screen devices while their screens are facing the sun may provide significant practical benefit and greatly improve the utility of such devices. No such device is available commercially, and the inventors know of no such device discovered or described by anyone else. Thus, it would be advantageous to selectively block NIR radiation from entering through the touch-screen while at the same time allowing the visible radiation to enter freely.

To block radiation from entering through a surface, it must either be absorbed or reflected. If the radiation is neither absorbed nor reflected by the surface it will be transmitted though the surface.

Many metals are known to effectively reflect thermal (IR) radiation. Common among them are gold, silver, copper and aluminum. Similarly, several ceramic materials are known to strongly absorb IR radiation. Examples are oxides, mixed oxides, nitrides, borides and fluorides of several metals. Among the commonly used IR-absorbing ceramics are: titanium oxide, titanium nitride, niobium oxide, tantalum oxide, silicon oxide, aluminum oxide, zirconium oxide, zirconium nitride, tin oxide, indium oxide, lanthanum hexaboride, and magnesium fluoride. Metal films or coatings made of aluminum, copper, silver, gold, nickel, platinum, chromium, molybdenum, tungsten, niobium, tantalum, manganese, or their alloys have been used effectively to block all types of thermal radiation.

Many ceramic materials are commercially used to block propagation of thermal radiation. The only problem of using either metals or ceramics to block IR radiation in touch-screen devices is that, in their bulk state, they also block (reflect or absorb) visible radiation. This is not acceptable for use in touch-screen devices. However, when these substances are reduced to ultrathin films or very small particles, in some cases, also of appropriate shapes, and are applied to or dispersed in a medium, they become transparent to visible light and yet retain their ability to reflect or absorb thermal radiation.

Low thermal emissivity glass is a case in point. Thermal emissivity of a material is defined as a ratio of heat emitted compared to a black body in a scale of 0 to 1. A black body which absorbs all the IR radiation it receives (and turns it into heat) and reflects nothing back, is said to have emissivity of 1. Similarly, a surface that reflects all the radiation that falls on it back to the atmosphere and absorbs nothing is a perfect reflector and is said to have an emissivity value of 0. Reflectance is a measure inversely correlated to emissivity. Thus, a substance that has an emissivity value of 0.1 is said to have a reflectance value of 0.9. Measured by this scale, smooth uncoated glass exhibits an emissivity value of 0.91 and reflectance value of 0.09. Most of the metal and ceramic materials of the type mentioned above have emissivity values below 0.03 and reflectance values above 0.97. When a glass surface is coated with nano-sized ceramic particles like fluorinated tin oxide (SnO₂:F) by a pyrolytic chemical vapor deposition technique, its thermal emissivity values drop drastically, reaching values close to 0.02, but their ability to transmit visible light remains virtually unchanged. Other methods of applying low-e coatings, comprising metal/ceramic coatings on glass, also uses pyrolytic processes, the only difference being that they are applied on hot glass ribbons as they are being produced in a flat-glass manufacturing line. Though these glasses have excellent heat barriers, the processes by which the barrier coatings are applied are not suitable for applying such coatings on the glass overlay of a touch-screen device.

Alternative ambient temperature methods of providing infrared protection, while still allowing all visible light to freely pass through, are also known. These involve incorporating the protective pigments within a plastic film and then applying the film on the top of the glass. Such heat-blocking transparent films should, in principle, be suited for applying them on the outside as an overlay to prevent and/or retard entry of thermal radiation through the touch-screens of the electronic devices. European patent application EP 22213452 A1 provides a workable description of such transparent IR-reflective plastic films, which contain nano-sized refractory ceramic particles and/or ultrathin metal films. This patent also describes methods for attaching such films on glass surfaces. This patent application, EP 22213452 A1, and the references cited in it are incorporated herein by reference.

FUJIFILM Corporation recently described a visually transparent near-infrared reflecting plastic film containing disk-shaped silver nano-particles in its internal publication—Fujifilm Research & Development (No. 58-2013). This publication is incorporated herein by reference.

All-plastic multilayer NIR-reflecting films that are free of metals and/or ceramic particles and are transparent to visible light have also been described. The multilayer polymer technology depends on using alternative layers of two or more different polymers having sufficiently different refractive indices. Such films are typically made by co-extrusion of tens or hundreds of layers of the alternative polymers followed by optionally passing the multilayer extrudate through one or more multiplication dies and then stretching or otherwise orienting the extrudate to form a film. Each layer in the film is made so thin that light reflected at the plurality of interfaces can undergo, depending on precise thickness of the layers and refractive indices of the polymers, either constructive or destructive interference thus giving the film either reflective or transmissive properties and these properties can be designed to provide transmission of light in one range of wavelengths and reflection in another range. In this way all-polymer films, of optical thickness ranging from 0.09 to 0.45 micrometers, have been made that can transmit visible light and at the same time reflect NIR light. Optical thickness is defined as the product of multiplication of thickness and refractive index. Various polymer pairs have been used to form many visually transparent NIR reflective all-polymer films. Examples of two-polymer multilayer systems are: a) polyethylene terephthalate (PET) and polymethylmethacrylatye (PMMA); and b) polyethylene naphthalalte (PEN) and PMMA.

Multilayer polymer films have been described in U.S. Pat. Nos. 4,446,305; 4,540,623; 5,103,337; 5,233,465; 5,360,659; and 5,448,404. U.S. Pat. No. 6,352,761 discloses various polymer pairs or combinations that can be used for making IR-reflective films that are optically transparent. These patents are incorporated in their entirety by reference herein.

There are various ways visually transparent NIR-blocking films—either belonging to the metal/ceramic-based technology or multilayer optical interference technology, or both—can be attached to another substrate. U.S. Patent Pub. No. 20140098414 A1 describes an adhesive composition, preferably made of acrylic polymers to attach IR-reflecting films on glass surfaces. U.S. Pat. No. 7,727,633 B2 describes an adhesive layer comprising of curable acrylate/epoxy material, such as those described in U.S. Pat. No. 6,887,917 B2 and U.S. Pat. No. 6,949,297 B2, and which additionally contains IR absorbing nano-particles for attaching IR-reflecting films on other substrates. These patents and references cited therein are incorporated herein by reference. Other types of adhesion-promoting materials can also be used as can be readily visualized by those skilled in the art.

Because of the constructs of multifunctional modern hand-held touch-screen devices, it is impossible to predict which kind of visually transparent NIR-blocking films will be compatible with touch-screen devices and will work (or if any of them will at all work) as overlays on the screens to prolong the time before the devices turn off due to overheating and also allow the operation of the devices through their touch interfaces. After several trials and errors, we discovered that not all types of touch-screen devices respond equally in terms of operation of the device when covered with different types of IR-blocking films. Only one type of those tested, namely, the multilayer optical interference type NIR-reflecting films worked on the capacitive type touch-screen electronic devices (the most important type used in handheld devices) to prolong their working time under conditions of IR heating and also allow the operation of the device through its touch interface. The multilayer optical interference type NIR-reflecting films also worked well on all other types of touch-screens. We further discovered that IR-blocking films that depended on metal/ceramic-based technology worked only on devices that had resistive-type touch-screens. These metal/ceramic-based films did not work on devices with capacitive-type touch-screens because they interfered with the normal operation of devices. We further discovered that the transparent IR-blocking films of either kind could either be permanently attached with an adhesive or in a removable fashion using static charges on the films and the screens.

Several companies currently provide screen protectors containing ultrathin tempered glass plates as a top layer to provide oil and scratch resistance to touch-screens of electronic devices. U.S. Patent Application Pub. No 2011/0285932 A1 describes such a protection device and method of mounting them on the touch-screens. Some of these protection devices, such as Invisibleshields®, also come as a multilayer systems comprising an ultrathin tempered glass plate with oil-resistant nano-coating as the two top layer and an adhesive layer to attach the protection device on the touch-screen. None of these devices, however, provide protection against overheating by thermal radiations. An exemplary embodiment of a plastic film described herein in combination with such protection devices provides both scratch/oil resistance as well as protection against thermal radiations.

The use and utility of touch-screen devices and more particularly MTSHED's, such as smartphones and tablets, are necessarily reduced in situations where they are subject to direct sunlight because the time of operation and battery life are significantly reduced under solar heating conditions.

It would be desirable to have a method and apparatus that is visually transparent and allows the normal operation of the underlying touch-screen device while reducing the solar heat gain of the touch-screen device. More specifically, it would be desirable to have a method and apparatus that is visually transparent and allows the normal operation of underlying MTSHED's with capacitive type touch-screen interfaces while reducing the solar heat gain of the touch-screen device.

Certain touch-screen displays when viewed through polarized sunglasses turn black when viewed in one type of orientation (i.e. portrait or landscape) but not both orientations. This may be a result of a specific direction (A) of polarization of the light emitted from the display screen. The visible light emitted from the display screen is blocked by the polarization of the sunglasses of a user when the display is oriented in a direction which is 90 degrees different from the orientation of the polarization of the sunglasses (B). This prevents a user from viewing the screen in one of the orientations while wearing polarized sunglasses. It would be desirable to provide a method and apparatus that allow a user to use a touch-screen display in various orientations while wearing polarized sunglasses.

Exemplary embodiments of the present invention are based, at least in part, on the surprising discovery that unlike most transparent infrared barriers, multi-layer, polymeric infrared barriers when applied in the form of a screen protection device on touch-screen devices simultaneously reduced the solar heat gain and increased the operable time in direct sunlight of the touch-screen devices while allowing normal operation of the touch-screen interface, including, most surprisingly capacitive type touch-screen interfaces.

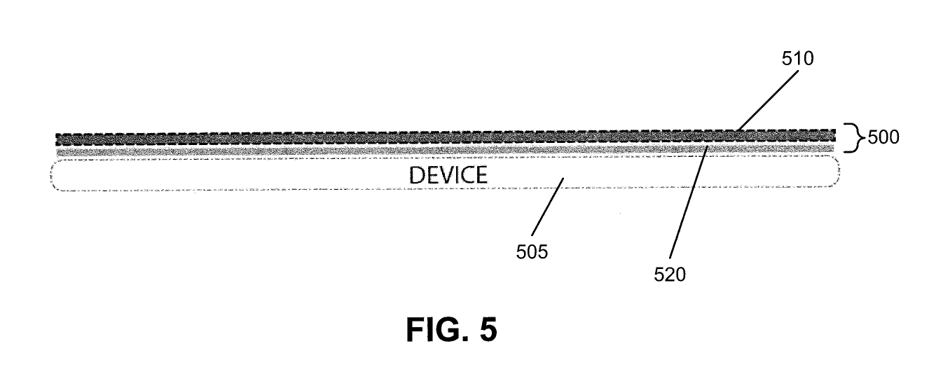

Referring now to FIG. 5, there is illustrated a touch-screen covering 500 which is visually transparent and allows normal operation of a touch-screen device 505, in accordance with an exemplary embodiment of the present invention. The touch-screen apparatus 500 reduces the solar heat gain of the touch-screen device 505 to allow for increased time of operation in direct sunlight. The touch-screen covering 500 comprises a visually transparent, multi-layer polymeric IR barrier layer 510.

The touch-screen covering 500 further comprises an adhesive layer 520 disposed on an inside surface of the IR barrier layer 510. The adhesive layer 520 adheres the IR barrier layer 510 to the touch-screen device 505. In an exemplary embodiment, the adhesive layer 520 is formed from a releasable adhesive so that the touch-screen covering 500 may be removed by a user from the touch-screen device 505.

In an exemplary embodiment of the touch-screen covering 500, the touch-screen covering 500 does not include the adhesive layer 520. In such embodiment, the IR barrier layer 510 is placed directly upon the screen of the touch-screen device 505 and remains in place through electrostatic attraction between the IR barrier layer 510 and the touch-screen device 505.

The touch-screen device 505 may be a MTSHED with a capacitive type touch-screen interface. In such embodiment, the touch-screen covering 500 is a visually transparent, protective heat shield which allows the normal operation of the MTSHED 505. Other exemplary embodiments in which the touch-screen device 505 may be a MTSHED with a resistive touch-screen interface, a surface acoustic wave touch-screen interface, or an acoustic pulse recognition touch-screen interface.

Continuing with FIG. 5, advantageously, the multi-layer polymeric infrared barrier film 510 reduces the solar heat gain of the underlying device 505 while allowing normal operation of the device 505. More advantageously, the use of the multi-layer polymeric IR barrier film 510, unlike the majority of other types of infrared barrier films, allows normal operation of capacitive type touch-screen devices.

In an exemplary embodiment of the touch-screen covering 500, the multi-layer polymeric IR barrier film 510 comprises two or more substantially transparent alternative polymer layers, each with different refractive indices and each having an optical thickness between about 0.09 and 0.45 micrometers. In such embodiment, the two or more substantially transparent alternative polymer layers include either polyethylene terephthalate (PET) and polymethylmethacrylate (PMMA) or polyethylene naphthalalte (PEN) and PMMA. A third layer of substantially transparent polymeric material having a refractive index between the first and second layers may be included.

In another embodiment, the multi-layer polymeric IR barrier film 510 is a visually transparent multilayer near-infrared reflecting film selected from PR 40® or PR 70® film from the 3M Company. The selected one of the PR-40® or PR-70® film is used singly or in combination in two or more layers, the two or more layers being superimposed on one another.

In still another exemplary embodiment, the multi-layer polymeric IR barrier film 510 comprises a visually transparent film comprising nano-sized NIR absorbing ceramic particles. The nano-sized NIR absorbing ceramic particles are selected from one or more of titanium oxide, titanium nitride, titanium oxynitride, niobium oxide, tantalum oxide, silicon oxide, aluminum oxide, zirconium oxide, zirconium nitride, tin oxide, indium oxide, lanthanum hexaboride, and magnesium fluoride. The multi-layer polymeric IR barrier film 510 may be formed from one or more layers of Select Tech®, Ceramic 30®, Ceramic 50® and Therm-X® from Huper Optik.

In yet another exemplary embodiment, the multi-layer polymeric IR barrier film 510 is a visually transparent near-infrared reflecting plastic film comprising a plurality of ultrathin metal films, wherein at least one of the ultrathin metal films is formed from a metal selected from aluminum, copper, silver, gold, nickel, platinum, chromium, molybdenum, tungsten, niobium, tantalum, manganese, or an alloy comprising at least one of aluminum, copper, silver, gold, nickel, platinum, chromium, molybdenum, tungsten, niobium, tantalum, and manganese.

In still yet another exemplary embodiment of the touch-screen covering 500, the multi-layer polymeric IR barrier film 510 is one that contains a minimum of 200 polymeric layers and has a final thickness of between 2 and 25 mils. In another exemplary embodiment of the touch-screen covering 500, the multi-layer polymeric IR barrier film 510 has a minimum of 500 polymeric layers and has a final thickness of between 5 and 15 mils. In an exemplary embodiment, the thickness of the touch-screen covering 500 is less than 25 mils.

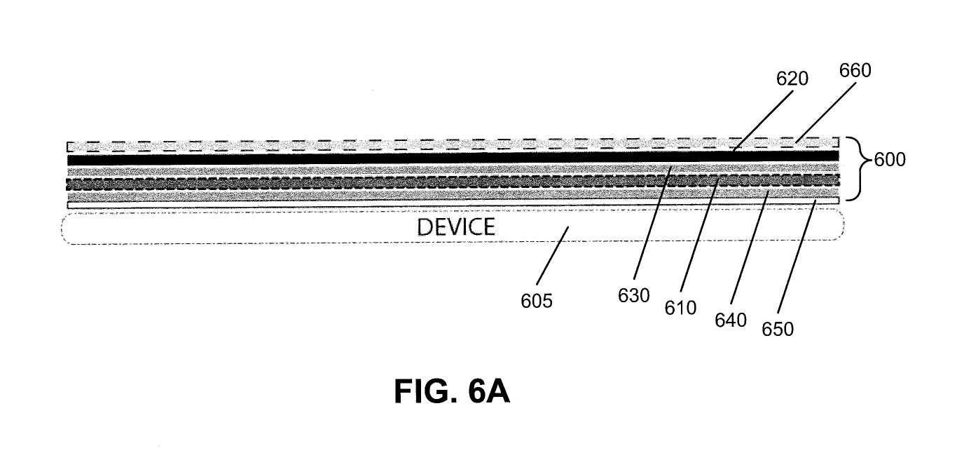

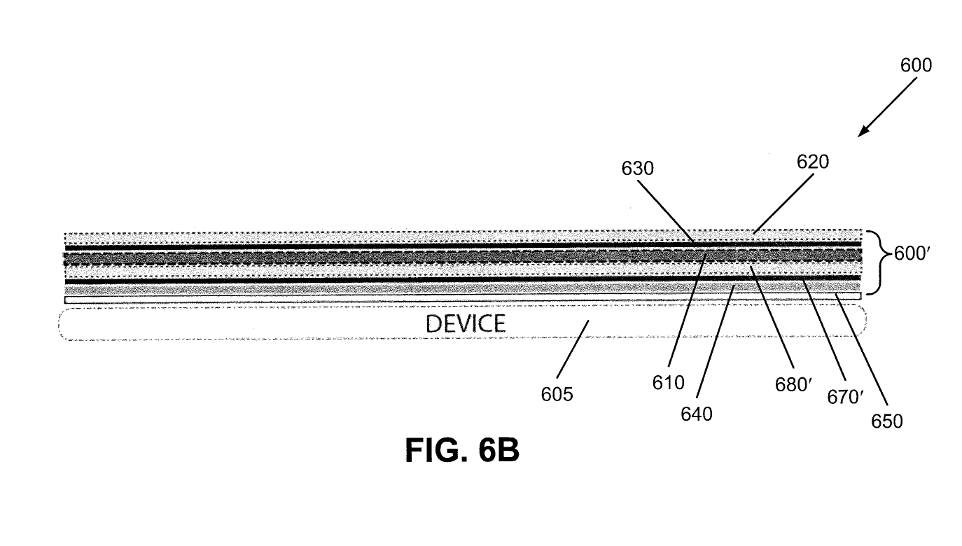

Referring now to FIG. 6A, there is illustrated a touch-screen covering 600 which is visually transparent and allows normal operation of a touch-screen device 605, in accordance with an exemplary embodiment of the present invention. The touch-screen apparatus 600 reduces the solar heat gain of the touch-screen device 605 to allow for increased time of operation in direct sunlight. The touch-screen covering 600 comprises a visually transparent, multi-layer polymeric IR barrier layer 610, a protective layer 620, and a pressure sensitive adhesive layer 630 disposed between the IR barrier layer 610 and the protective layer 620 to secure the protective layer 620 to the IR barrier layer 610.

The protective layer 620 may be a plastic film having strong surface hardness for scratch resistance. In an exemplary embodiment, it may be made of polyethylene terephthalate (PET) or polycycloolefins, particularly with polynonbornene, as described in U.S. Patent Application Pub. No. 2014/0098414.

The touch-screen covering 600 further comprises an adhesive layer 640 disposed on an inside surface of the IR barrier layer 610. The adhesive layer 640 adheres the IR barrier layer 610 to the touch-screen device 605. In an exemplary embodiment, the adhesive layer 640 is formed from a releasable adhesive so that the touch-screen covering 600 may be removed by a user from the touch-screen device 605. The touch-screen covering 600 further comprises a disposable release liner 650 disposed on an inside surface of the IR barrier layer 610. Although illustrated in FIG. 6A, the disposable release liner 650 is removed from the adhesive layer 640 prior to application of the touch-screen covering 600 to the screen of the device 605.

In an exemplary embodiment of the touch-screen covering 600, the touch-screen covering 600 does not include the adhesive layer 640. In such embodiment, the IR barrier layer 610 is placed directly upon the screen of the touch-screen device 605 and remains in place through electrostatic attraction between the IR barrier layer 610 and the touch-screen device 605.

The touch-screen device 605 may be a MTSHED with a capacitive type touch-screen interface. In such embodiment, the touch-screen covering 600 is a visually transparent, protective heat shield which allows the normal operation of the MTSHED 605. Other exemplary embodiments in which the touch-screen device 505 may be a MTSHED with a resistive touch-screen interface, a surface acoustic wave touch-screen interface, or an acoustic pulse recognition touch-screen interface.

Continuing with FIG. 6A, advantageously, the multi-layer polymeric infrared barrier film 610 reduces the solar heat gain of the underlying device 605 while allowing normal operation of the device 605. More advantageously, the use of the multi-layer polymeric IR barrier film 610, unlike the majority of other types of infrared barrier films, allows normal operation of capacitive type touch-screen devices.

In an exemplary embodiment of the touch-screen covering 600, the multi-layer polymeric IR barrier film 610 comprises two or more substantially transparent alternative polymer layers, each with different refractive indices and each having an optical thickness between about 0.09 and 0.45 micrometers. In such embodiment, the two or more substantially transparent alternative polymer layers include either polyethylene terephthalate (PET) and polymethylmethacrylate (PMMA) or polyethylene naphthalalte (PEN) and PMMA. A third layer of substantially transparent polymeric material having a refractive index between the first and second layers may be included.

In another embodiment, the multi-layer polymeric IR barrier film 610 is a visually transparent multilayer near-infrared reflecting film selected from PR 40® or PR 70® film from the 3M Company. The selected one of the PR-40® or PR-70® film is used singly or in combination in two or more layers, the two or more layers being superimposed on one another.

In still another exemplary embodiment, the multi-layer polymeric IR barrier film 610 comprises a visually transparent film comprising nano-sized NIR absorbing ceramic particles. The nano-sized NIR absorbing ceramic particles are selected from one or more of titanium oxide, titanium nitride, titanium oxynitride, niobium oxide, tantalum oxide, silicon oxide, aluminum oxide, zirconium oxide, zirconium nitride, tin oxide, indium oxide, lanthanum hexaboride, and magnesium fluoride. The multi-layer polymeric IR barrier film 610 may be formed from one or more layers of Select Tech®, Ceramic 30®, Ceramic 50® and Therm-X® from Huper Optik.

In yet another exemplary embodiment, the multi-layer polymeric IR barrier film 610 is a visually transparent near-infrared reflecting plastic film comprising a plurality of ultrathin metal films, wherein at least one of the ultrathin metal films is formed from a metal selected from aluminum, copper, silver, gold, nickel, platinum, chromium, molybdenum, tungsten, niobium, tantalum, manganese, or an alloy comprising at least one of aluminum, copper, silver, gold, nickel, platinum, chromium, molybdenum, tungsten, niobium, tantalum, and manganese.

In yet another exemplary embodiment of the touch-screen covering 600, the multi-layer polymeric IR barrier film 610 is one that contains a minimum of 200 polymeric layers and has a final thickness of between 2 and 25 mils. In another exemplary embodiment of the touch-screen covering 600, the multi-layer polymeric IR barrier film 510 has a minimum of 500 polymeric layers and has a final thickness of between 5 and 15 mils. In an exemplary embodiment, the thickness of the touch-screen covering 600 is less than 25 mils.

The touch-screen covering 600 may further include a protective coating 660 applied to an outer surface of the protective layer 620. The protective coating 660 may be an oleophobic coating and/or other protective coatings, such as scratch resistant coatings. The device 605 having the touch-screen covering 600 disposed thereon will have multilevel protection including protection against scratching, oil (when the oleophobic coating 660 is used), and IR heating.

In an exemplary embodiment, a second protective substrate may be included in the touch-screen covering 600. Referring now to FIG. 6B, there is illustrated an exemplary alternative embodiment of the touch-screen covering 600, which embodiment is generally designated as 600′ in FIG. 6B, in accordance with an exemplary embodiment of the present invention. The touch-screen covering 600′ may include any of the layers of the touch-screen covering 600 described above and further includes a second protective layer 680′ disposed on an inner surface of the IR barrier layer 610 and a further adhesive layer 670′ disposed on an inner surface of the second protective layer 680′.

The second protective layer 680′ may also be a plastic film having strong surface hardness. It may be applied on the underside of the IR barrier film 610 to increase structural stability. It may be made of polyethylene terephthalate (PET) or polycycloolefins, particularly with polynonbornene, as described in U.S. Patent Application Pub. No. 2014/0098414, which is incorporated by reference herein in its entirety. In an exemplary embodiment, the thickness of the touch-screen covering 600′ is less than 25 mils.

The protective substrates 520, 620, and 680′ described herein may alternatively each be a single or multilayer ultra-thin, scratch-resistant tempered glass plate, and the protective substrates 520 and 620 may further comprise protective coatings. The device 605 having the touch-screen covering 600′ disposed thereon will have multilevel protection including protection against scratching, oil (when an oleophobic coating is used), and IR heating.

Desirably, though not required, the adhesive used to adhere the films and/or substrates in the devices 500, 600, and 600′ are polymeric adhesives. The adhesives may be those made of curable acrylate and acrylate/epoxy materials. These types of adhesives were found to be particularly suitable since acrylic resins can add to the IR-absorbing properties of the glued-in film 510, 610.

Transmission of near-infrared radiation through the touch-screens of MTSHEDs is primarily responsible for overheating of these devices when exposed to sunlight or to other sources of thermal radiation.

After experimenting with various types of visually transparent IR-reflecting films it has been determined that one kind, namely, optical interference films made of multiple layers of polymers of different refractive indices, that are designed to reflect wavelengths of light in the infrared region of the spectrum while being substantially transparent to wavelengths in the visible spectrum, when overlaid on touch-screens of all different types as the films 510, 610, can delay overheating of the devices 505, 605 without interfering with their operation. Other types of visually transparent IR-blocking plastic films particularly those that are based on nano-sized ceramic particles dispersed in the film, or interlaid with thin metallic films, when overlaid on the touch-screens, interfere with the workings of majority of them. In particular, the inventors found them to make MTSHEDs, the overwhelming majority of which contain capacitive type touch-screens, totally inoperative.

It has been found that when a multi-layer polymeric infrared film 510, 610 is employed as described above, the screen of the devices 505, 605 can be viewed by a user in multiple orientations, such as orientations that are 90° from one another, while wearing polarized sunglasses. The inventors believe that this is a result of the uni-directional polarized light exiting certain touch-screen displays, e.g., from the devices 505, 605, becoming partially or completely un-polarized (scattered), circularly polarized, or polarized in a different direction. As a result, the change in polarization allows the light to pass through the polarized sunglasses of the user.

The inventors further discovered that one kind of touch-screen electronic devices, namely, those where the touch-screen is based on resistive technology, work well when overlaid with transparent IR-blocking plastic films 510, 610 that have nano-sized ceramic particles dispersed in them or are built with ultrathin metallic films, as a means of blocking/retarding entry of near infrared radiation through the screens. Examples of thin films with pre-applied infrared blocking, absorbing or reflecting materials that may be used in exemplary embodiments of the present invention as the layer 510, 610, include, without limitation, Huper Optik®, Enerlogic®, Llumar®, Vista® and Gila® series films produced by Eastman Corporation, of Kingsport, Tenn.; and the Prestige, Ceramic, Ultra-Clear Solar and Night Vision Series films, including #M Ultra Clear, produced by 3M Company, of Saint Paul, Minn. More specifically, one example of a specific solar window film suitable for the present invention as the layer 510, 610 is Huper Optik® Select Sech, produced by Huper Optik®, a subsidiary of the Eastman Corporation, of Kingsport, Tenn. These films are relatively inexpensive and can withstand abuses such as scratching during use by children. The inventors found them to be particularly suitable for use in videogame devices with resistive touch-screens, like the Nintendo wii-u controller. One additional advantage was that one could use an adhesive dispersed with the same type of IR-absorbing ceramic particles to attach them on the screens thus providing the devices extended workable time in the sun.

### EXAMPLES

Several examples are provided below.

### Example 1

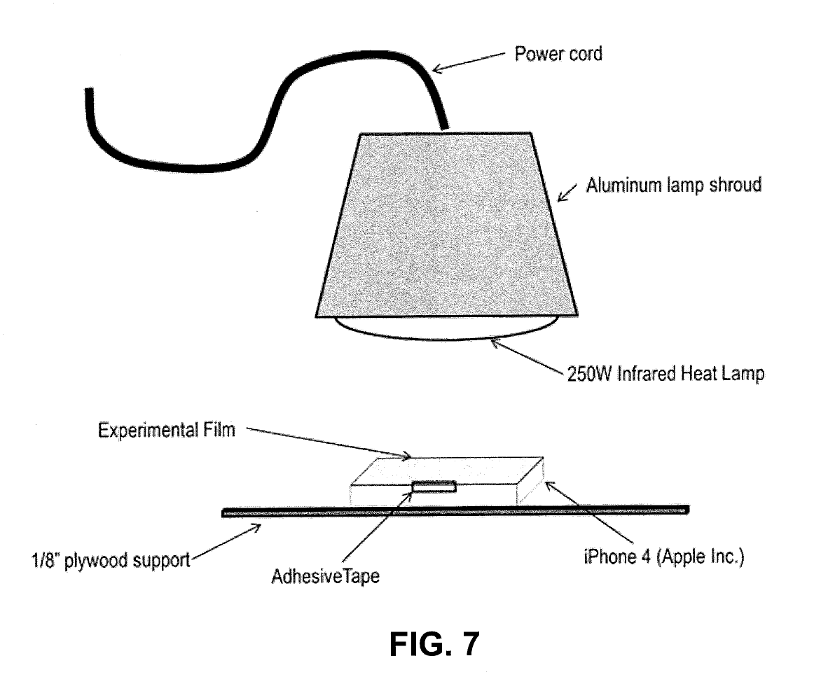

An experimental apparatus was assembled to test the effect of infrared blocking, reflecting or absorbing materials on the length of time before shutdown of electronic devices. The experimental apparatus (FIG. 7) comprised a Phillips Model 415836 Heat Lamp 250 Watt R40 Flood Light Bulb placed inside an aluminum protective shroud. The entire lamp assembly was suspended 11 inches from a ⅛ inch plywood support surface by means of a clamp and support. The handheld touch-screen electronic device used for the testing was an iPhone 4 manufactured by Apple, Inc.

### Example 2

Using the apparatus from Example 1, four (4) different infrared blocking, reflecting or absorbing solar window films were tested (see Table 1). They were mounted to a ⅛-inch plywood support using adhesive tape. A 250 W infrared heat lamp with an aluminum lamp shroud was used for applying infrared radiation to the tested films. For each experiment, starting and failing temperatures of an Apple iPhone 4 was measured using a Nubee® NUB8380 Temperature Gun Non-contact Infrared Thermometer. The room temperature was controlled to 75 deg. F. The time was measured using a stopwatch. The device was deemed to fail when the iPhone 4 internal temperature sensor displayed the temperature shutdown warning screen. The results which demonstrate over 300% improvement in time before failure are shown in Table 2.

TABLE 1

| Solar Film | | | | Infrared |
|---|---|---|---|---|
| Grade | Manufacturer | Type | VLT % | Rejection % |
| Select Sech | Huper Optik | Ceramic/ | 59 | 83 |
| | | Metallized | | |
| Ceramic 30 | Huper Optik | Ceramic | 30 | 86 |
| Ceramic 50 | Huper Optik | Ceramic | 52 | 69 |
| Therm-X | Huper Optik | Ceramic/ | 70 | 76 |
| | | Metallized | | |
| Prestige PR70 | 3M | Polymeric | 69 | 97 |
| Prestige PR40 | 3M | Polymeric | 39 | 97 |

TABLE 2

| | | | | | | |
|---|---|---|---|---|---|---|
| | | | | | | Increase in |
| | | | | Increase in | | Resistance |
| | Start Temp | Failure Temp | Time Before | Time Before | Heat Gain | to |
| Film (Configuraton) | (deg F.) | (deg F.) | Failure (min) | Failure | (deg F./Min) | Heat Gain |

CONTROL

| | | | | | | |
|---|---|---|---|---|---|---|
| No Film (Control) | 77 | 124 | 12 | n/a | 3.92 | n/a |

CERAMIC/METALLIZED BARRIERS

| | | | | | | |
|---|---|---|---|---|---|---|
| Select Sech | 74 | 126 | 31 | 258% | 1.68 | 233% |
| Ceramic 30 | 73 | 131 | 20 | 167% | 2.90 | 135% |
| Select Sech 2 layers | 77 | 124 | 38 | 317% | 1.24 | 317% |
| Ceramic 50 | 77 | 123 | 23 | 192% | 2.00 | 196% |
| Therm-X | 77 | 123 | 28 | 233% | 1.64 | 238% |
| Therm-X 2 layers | 75 | 122 | 36 | 300% | 1.31 | 300% |
| Therm-X/Select Sech | 77 | 125 | 30 | 250% | 1.60 | 245% |

POLYMERIC BARRIERS

| | | | | | | |
|---|---|---|---|---|---|---|
| PR 70 | 74 | 122 | 27 | 225% | 1.78 | 220% |
| PR 40 | 73 | 119 | 34 | 283% | 1.35 | 289% |

### Example 3

Using the same films in Example 2, two different types of touch-screens were tested for functionality by attempting to operate the device with a bare finger. Immediate response similar to the control (no film) was deemed to be operational (working), whereas no response or diffused and unexpected response was determined to be non-operational (not working) The devices tested were an Apple iPhone 4 (capacitive touch-screen) and a Nintendo Wii-U controller (resistive touch-screen). The results are shown in Table 3.

TABLE 3

| | Touch Performance | |
|---|---|---|
| | | Resistive |
| | Capacitive | Nintendo Wii-U |
| Film | (Apple iPhone 4) | Controller |
| CONTROL | | |
| No Film (Control) | W | W |
| CERAMIC BARRIERS | | |
| Select Sech | NW | W |
| Ceramic 30 | NW | W |
| Select Sech 2 layers | NW | W |
| Ceramic 50 | NW | W |
| Therm-X | NW | W |
| Therm-X 2 layers | NW | W |
| Therm-X/Select Sech | NW | W |
| POLYMERIC BARRIERS | | |
| PR 70 | W | W |
| PR 40 | W | W |

W = Working;
NW = Not Working

What is claimed is:

1. A multifunctional touch-screen device comprising:
a touch-screen; and
a visually transparent infrared (IR)-blocking film overlaid on the touch-screen, whereby the visually transparent IR-blocking film provides prolonged workable time under conditions when the device is exposed to sunlight or to other sources of thermal radiation.

2. The multifunctional touch-screen device of claim 1, wherein the touch-screen is a capacitive touch-screen.

3. The multifunctional touch-screen device of claim 1, wherein the touch-screen is a resistive touch-screen.

4. The multifunctional touch-screen device of claim 1, where the touch-screen is a surface acoustic wave (SAW) touch-screen.

5. The multifunctional touch-screen device of claim 1, where the touch-screen is an acoustic pulse recognition (APR) touch-screen.

6. The multifunctional touch-screen device of claim 1, where the visually transparent IR-blocking film is a visually transparent near-infrared reflecting multilayer optical interference film.

7. The multifunctional touch-screen device of claim 6, where the multilayer optical interference film comprises two or more visually transparent alternating polymers layers, each with different refractive indices and each comprising an optical thickness between about 0.09 and 0.45 micrometers.

8. The multifunctional touch-screen device of claim 6, wherein the multilayer optical interference film comprises two polymers of different refractive indices.

9. The multifunctional touch-screen device of claim 8, wherein the two polymers are either polyethylene terephthalate (PET) and polymethylmethacrylate (PMMA) or polyethylene naphthalalte (PEN) and PMMA.

10. The multifunctional touch-screen device of claim 7, wherein the multilayer optical interface film comprises first, second, and third visually transparent polymeric materials having different refractive indices, each layer comprising an optical thickness of between about 0.09 and 0.45 micrometers, and the refractive index of the second visually transparent polymeric material being intermediate the refractive indices of the first and third visually transparent polymeric materials.

11. The multifunctional touch-screen device of claim 1, wherein the visually transparent IR-blocking film is a visually transparent multilayer near-infrared reflecting film selected from PR 40®, PR 70®, or #M Ultra Clear film from the 3M Company.

12. The multifunctional touch-screen device of claim 11, wherein the selected one of the PR-40®, PR-70®, or #M Ultra Clear film is used singly or in combination in two or more layers, the two or more layers being superimposed on one another.

13. The multifunctional touch-screen device of claim 1, wherein the visually transparent IR-blocking film is a visually transparent film comprising nano-sized near IR (NIR) absorbing ceramic particles and an optically clear film forming polymer.

14. The multifunctional touch-screen device of claim 13, wherein the nano-sized NIR absorbing ceramic particles are selected from one or more of titanium oxide, titanium nitride, niobium oxide, tantalum oxide, silicon oxide, aluminum oxide, zirconium oxide, zirconium nitride, tin oxide, indium oxide, lanthanum hexaboride, and magnesium fluoride.

15. The multifunctional touch-screen device of claim 13, wherein the nano-sized ceramic particles are titanium oxynitride.

16. The multifunctional touch-screen device of claim 13, wherein the visually transparent IR-blocking film comprises one or more layers of Select Tech®, Ceramic 30®, Ceramic 50® and Therm-X® from Huper Optik.

17. A method for attaching an IR-blocking film, the method comprising:
providing a multifunctional touch-screen device comprising a touch-screen; and
attaching a visually transparent infrared (IR)-blocking film to the touch-screen using a polymeric adhesive, whereby the visually transparent IR-blocking film provides prolonged workable time under conditions when the device is exposed to sunlight or to other sources of thermal radiation.

18. The method of claim 17, wherein the polymeric adhesive is a curable acrylate and acrylate/epoxy material.

19. The method of claim 18, where the acrylate is polymethylmethylmethacrylate.

20. A method for attaching a visually transparent IR-blocking film, the method comprising:
providing a multifunctional touch-screen device comprising a touch-screen;
providing a visually transparent multilayer near-infrared (NIR) reflecting film selected from PR 40® or PR 70® film from the 3M Company;
cutting the visually transparent multilayer NIR reflecting film into a size of the touch-screen; and
sticking the visually transparent multilayer NIR reflecting film to the touch-screen by electrostatic attraction.

21. The multifunctional touch-screen device of claim 1, wherein the visually transparent IR-blocking film is laminated with a scratch-resistant plastic film.

22. The multifunctional touch-screen device of claim 21, wherein the scratch resistant film comprises polyethylene terephthalate.

23. The multifunctional touch-screen device of claim 21, wherein the scratch resistant film comprises polynorbornene.

24. The multifunctional touch-screen device of claim 1, wherein the visually transparent IR blocking film is overlaid or laminated with an ultrathin scratch resistant tempered glass plate.

25. The multifunctional touch-screen device of claim 1, whereby the visually transparent IR-blocking film changes polarization of light emitted by the touch-screen.
